(19) United States
(12) Patent Application Publication
(10) Pub. No.: US 2026/0284908 A1
(43) Pub. Date: Sep. 24, 2026

(54) Retaining Device

(71) Applicant: HYDAC PTK Produktionstechnik GmbH, Sulzbach / Saar (DE)

(72) Inventors: Daniel Welker, Zweibrücken (DE); Erich Karl Heinz Bohnen, Neunkirchen (DE)

(73) Assignee: HYDAC PTK Produktionstechnik GmbH, Sulzbach / Saar (DE)

(21) Appl. No.: 19/475,649

(22) PCT Filed: Mar. 27, 2024
(86) PCT No.: PCT/EP2024/058287

§ 371 Date: Oct. 15, 2025

(30) Foreign Application Priority Data
Apr. 21, 2023 (DE) 10 2023 001 583.0

(51) Int. Cl. B25J 15/04

(52) U.S. Cl. CPC B25J 15/0408; B25J 15/0491

(57) ABSTRACT

The disclosure relates to a retaining device with at least a base unit and a changing unit. The base unit and changing unit being longitudinally movable relative to each other in a guided manner from a locking position, in which the base unit and the changing unit are connected, into a release position, in which the two units are separated, and vice versa.

### CROSS-REFERENCE TO RELATED APPLICATIONS

This application claims priority to German Patent Application DE 10 2023 001 583.0, filed on Apr. 21, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a retaining device.

DE 10 2019 104 484 B3 discloses a retaining device in the form of a gripping or clamping device, having a housing body and having at least one jaw guide provided in the housing body, said jaw guide having two side walls with at least one jaw that can be moved in the jaw guide along a movement direction, wherein guide faces are provided on the side walls, and wherein the jaw has sliding surfaces interacting with the guide faces to form a sliding guide. In such retaining devices it is necessary to guide the jaws in the jaw guides in a very precise manner with simultaneously smooth-running guidance. With the known retaining device, jaws arranged opposite one another in the guide can be moved towards and onto one another for retaining, gripping or clamping, starting from an initial position into a corresponding functional position.

EP 3 927 504 B1 discloses a retaining device in the form of a clamping or gripping device, having a main body, with guiding portions, which are provided on the main body, and having jaws that can be moved in a movement direction along the guiding portions and can be moved between an inner end-of-stroke position and an outer end-of-stroke position, said jaws each having a row-of-teeth portion, in each case having a length extending in the movement direction, multiple pinions being provided, the axes of rotation of said pinions lying in a plane lying parallel to the respective row-of-teeth portions and said pinions interacting with the respective row-of-teeth portion to drive the jaws. Furthermore, angular top jaws are provided as grippers, which can be fixed to the driveable jaws and grip or clamp, and thus retain, individual third-party components between them.

According to the gripping or clamping task, an independent jaw or gripper solution must be provided for each individual case, which is correspondingly intensive in terms of costs and materials.

### SUMMARY

A need exists to provide an improved solution for a retaining device. The need is addressed by the subject matter of the independent claim(s). Embodiments of the invention are described in the dependent claims, the following description, and the drawings.

### BRIEF DESCRIPTION OF THE DRAWINGS

FIG. 1 shows a very simplified representation of an example actuating device, by means of which two positioned retaining devices can be moved towards and onto or away from one another as a pair;

FIG. 2 shows the pair of example retaining devices according to FIG. 1, each consisting of a base unit and an interchangeable unit, which are coupled to one another;

FIG. 3 shows an uncoupled position of the interchangeable unit with the base unit according to FIG. 2;

FIG. 4 is a depiction corresponding to FIG. 3 without clamping elements for the respective interchangeable unit;

FIG. 5 takes the form of an exploded view showing part of an example storage apparatus on which the interchangeable units according to FIG. 1 to 4 can be deposited; and

FIGS. 6 and 7 show example interchangeable units intended to be deposited on the storage apparatus in two functional positions; one just before stopping and one in the stopped state respectively, with the storage apparatus.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a retaining device consists at least of a base unit and an interchangeable unit, said units being longitudinally movable relative to each other in a guided manner from a locking position, in which the units are connected together, into a release position, in which the two units are separated, and vice versa. In this manner, independent retaining jaws or grippers do not need to be provided for each task; instead, it is sufficient to design one base unit of the retaining device as a standardised structural component for most, for example all, applications and to structurally adapt only one interchangeable unit that can be coupled to the base unit in each case, for the actual ‘retaining’, ‘gripping’ or ‘clamping’ task. In this manner, in the form of a modular system with only a few components in the form of the standardised base unit and the individual interchangeable unit to be adapted to the respective task, a large number of retaining, gripping and clamping tasks can be solved. The corresponding replacement and exchange concept has huge savings potential due to reducing the number of parts and allows increased flexibility in the practical handling of assembly and processing tasks. Due to the modular construction concept, novel retaining tasks can also be solved, which was not previously possible in this manner with conventional jaw or gripper systems.

In some embodiments, it is provided that, by means of a fixing apparatus acting between the base unit and the interchangeable unit, in a movement position of the units relative to one another, these units are coupled to one another in the locking position and, in a further movement position, which corresponds to the release position, the two units are uncoupled from one another. In this manner, only small masses ever need to be moved for switching-in and out operations, which proves to be favourable in energy terms, and reliable guidance of the base and interchangeable unit is guaranteed at all times, these forming a jaw in the corresponding interaction, which serves to grip or clamp third-party components such as metal plates and the like.

In some embodiments, it is provided that the fixing apparatus comprises individual fixing means and associated gripping means, which are moved towards and onto one another or away from one another and come into or out of engagement with one another respectively to reach the locking position or release position. In this case it is for example provided that the fixing means are formed by individual bolts, which are arranged in pairs, assigned to one another, on the two opposite longitudinal sides of the interchangeable unit, and in that the gripping means consist of individual hook elements on the base unit, which receive the assignable bolts via their hook opening for a locking operation in a longitudinal movement direction, or release said bolts in the opposite direction. A particularly functionally reliable structure for coupling and uncoupling the two units is achieved in this manner. By virtue of the bolt-hook configuration, high forces can also be achieved when the base unit and the interchangeable unit are in the locked state.

In some embodiments, it is provided that at least some of the bolts are held in the locking position inside the assignable hook elements by means of a detachable stopping apparatus/stop. This thus ensures that the bolts do not inadvertently come out of engagement with the hook elements and the interchangeable unit can thus detach from the base unit.

In some embodiments, it is provided that the hook elements are arranged in series behind one another and, with their openings pointing in one direction, delimit at least one longitudinal guide in which the respective assignable bolt may be positioned and moved from the release position along one longitudinal movement direction into the locking position. In this manner, secure positioning of the base unit on the interchangeable unit is possible and due to the longitudinal guide a secure latching operation between the respective bolt and the assignable hook element is guaranteed.

In some embodiments, it is provided that the base unit comprises a plate-shaped base body, on which the respective hook element protrudes in one direction and at least one coupling element protrudes in the opposite direction, said coupling element interacting with an actuating apparatus, which moves the base unit in the opposite directions in parallel with the respective longitudinal movement direction for feed movements. In this manner, the respective base unit can be coupled in a simple manner to the actuating apparatus, as is already disclosed in DE 10 2019 104 484 B3 and EP 3 927 504 B1 for controlling and moving jaws, incorporated by reference herein.

In this case it is for example provided that the interchangeable unit comprises individual clamping means such as
contact or support surfaces and/or
pendular supports and/or
gripper fingers

for fixing third-party components. In this manner, a plurality of clamping and fixing options can be incorporated in a space-saving manner in one component with one kind of interchangeable unit.

In some embodiments, it is provided that the interchangeable unit has individual receiving means on its side facing away from the base unit for depositing the interchangeable unit on a storage apparatus in the release position and that, for example by means of a further detachable stopping apparatus, the respective interchangeable unit can be fixed to the corresponding storage apparatus. In this manner, by means of only one kind of storage apparatus, interchangeable units stored therein with the same or different design can be retrieved by means of the base unit in an interchangeable manner and, for this purpose, the actuating apparatus can be moved, with the respective base unit, by means of a handling system, as disclosed in DE 10 2019 128 931 A1 by way of example, incorporated by reference herein. By means of the further detachable stopping apparatus, it can for example be provided that an interchangeable unit deposited on the storage apparatus remains securely in its storage position therein until it is retrieved therefrom once again by means of the associated base unit for further handling operations.

In some embodiments, a system is provided consisting of at least two retaining devices, each as described above, wherein, in order to apply or release a clamping force by means of the clamping means, the interchangeable units locked to the base units can be moved towards and onto or away from one another by means of the disclosed actuating apparatus. As such, the retaining device consisting of a base unit and, for example different, interchangeable units, as a structural unit, can be controlled by means of different actuating apparatuses.

The retaining device is discussed in greater detail below with reference to further embodiments according to the FIGS. The FIGS. are schematic and not necessarily to scale. Specific references to components, process steps, and other elements are not intended to be limiting. Further, it is understood that like parts bear the same or similar reference numerals when referring to alternate FIGS.

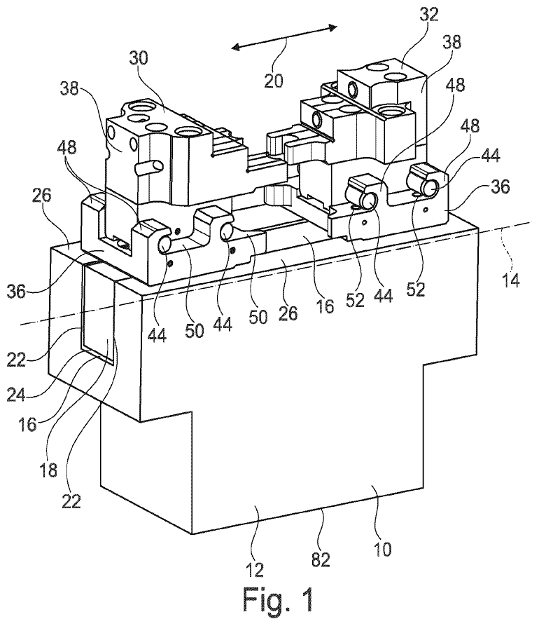

The actuating apparatus 10 shown in FIG. 1 has a housing body 12 with a jaw guide 16 extending in the longitudinal direction 14 through the housing body 12, said jaw guide being formed by a continuous profiled, viewed in cross-section, longitudinal groove in the housing body 12, which, as viewed on FIG. 1, is configured to be open towards the top and is also shown in a simplified rectangular form. Two jaws 18, which can be moved towards and onto one another and away from one another and are mounted such that they can be moved axially along a longitudinal movement direction that runs parallel to the longitudinal direction 14, are received in the jaw guide 16, only the front left-hand jaw of said jaws being reproduced in FIG. 1. The ability of the jaws 18 to move to and fro is shown in FIG. 1 by means of a double arrow 20. The jaw guide 16 has two side walls 22 opposite one another and a base 24 arranged between said walls. All walls 22 and the base 24 as well as the adjacent wall parts of the respective jaw 18 together form sliding surfaces such that the respective jaw 18 can be moved to and fro without obstacles and in a low-friction manner in the jaw guide 16 along the longitudinal direction 14. A corresponding structure of an actuating apparatus 10 is disclosed in DE 10 2019 104 484 B3 by way of example.

It is fundamentally possible to fix the jaws 18 manually by means of corresponding clamping means (not shown) in their respective movement position inside the jaw guide 16; however, it is also possible, as disclosed in EP 3 927 504 B1, to move the jaws 18 by means of a pinion drive (not shown) inside the jaw guide 16 and to fix said jaws at predefinable positions. Other drives are possible in this case, such as, for example, wedge kinematics, a gear wheel. etc.

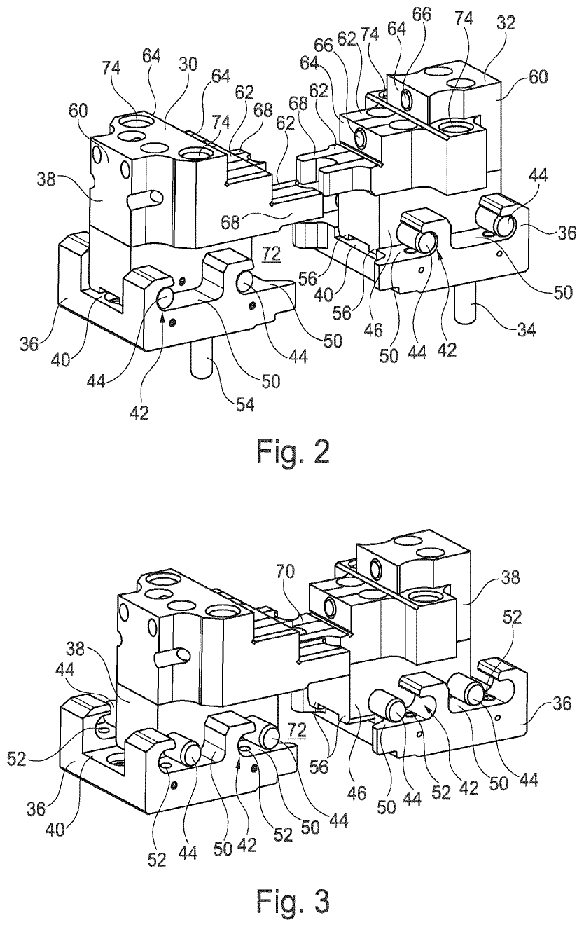

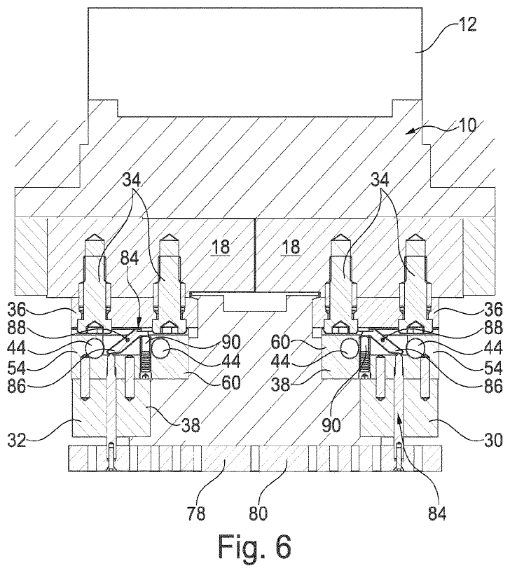

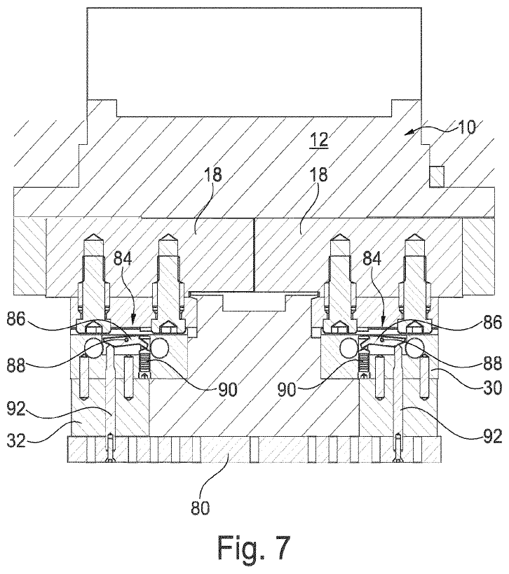

As is also shown on FIG. 1, the jaw guide 16 extends over the entire length of the housing body 12 and the two jaws 18 have a correspondingly smaller axial extension so as to, in this manner, permit, for example, a stroke per jaw 18 of 30 mm such that both jaws 18 together are able to execute a stroke of 60 mm towards and onto or away from one another, both jaws 18 being shown in FIG. 1 as for the left-hand jaw 18 in their initial or original position. Surfaces 26 are formed adjacent to the right and left on the channel-like or groove-shaped, respectively, jaw guide 16. Opposite thereto, two retaining devices 30, 32 are arranged such that they are positioned on the surfaces 26 running correspondingly horizontally at a predefinable distance and securely connected to the respectively assignable jaws 18 in a detachable manner, said retaining devices being shown in more detail in FIG. 2 to 4. In particular, the retaining device 30, 32 shown in FIG. 2 has at least one protruding coupling element 34 on its underside, for example in the form of a screw bolt, with which the respective coupling element 30, 32 can be fixed in a detachable manner to the jaw 18 that can be assigned thereto. In the drawings shown on FIGS. 6 and 7, two fixing screws are provided as coupling elements 34 for each jaw 18 for each retaining device 30, 32 in a modified configuration. Other fixing options are also conceivable in this case.

The respective retaining device 30, 32 consists at least of a base unit 36 and an interchangeable unit 38, which can be moved longitudinally relative to each other in a guided manner from a locking position, as shown in FIG. 2, in which said units are connected together, into a release position, as shown in FIG. 3, and vice versa, the interchangeable unit 38 being separated from the base unit 36 in the release position shown in FIG. 3. As is also shown in FIG. 1 to 4, the base unit 36 is formed by a plate-shaped base body with a through longitudinal groove 40, along which the positioned interchangeable unit 38 is guided such that it can move longitudinally until it reaches a stop as depicted on FIGS. 1 and 2, in which the bottom of the block-shaped interchangeable unit 38 engages precisely in the longitudinal groove 40 of the base unit 36. In this manner, a kind of rail system is obtained for guidance between the two units 36, 38.

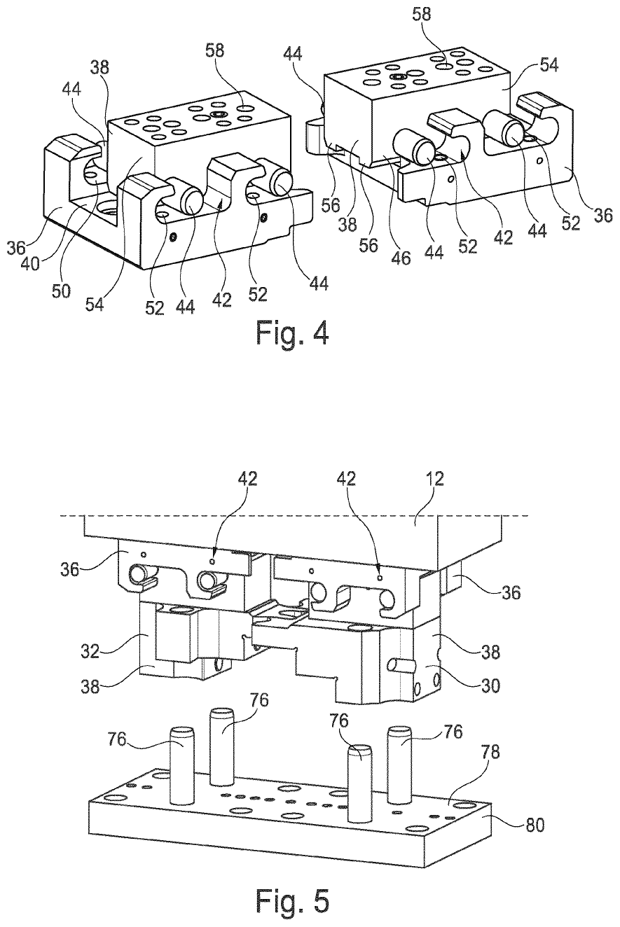

By means of a fixing apparatus 42 acting in its entirety between the base unit 36 and the interchangeable unit 38, in a movement position of the units 36, 38 relative to one another, these units are coupled to one another in the locking position as shown in FIGS. 1 and 2, and in a further movement position, which corresponds to the release position shown in FIGS. 3 and 4, they are correspondingly uncoupled from one another. In the uncoupled position, the respective interchangeable unit 38, as viewed on FIGS. 3 and 4, can be removed in the vertical direction from the remaining base unit 36. Conversely, of course, the interchangeable unit 38 can also be kept in a predefinable position and the base unit 36 can be positioned perpendicular thereto.

The fixing apparatus 42 comprises individual fixing means and associated gripping means, which can be moved towards and onto or away from one another to reach the locking position or the release position and come into or out of engagement with each other respectively. For this purpose, the fixing means are formed by individual solid bolts 44 with, for example, a circular cross-section, which are assigned to one another in pairs and arranged on the two opposite longitudinal sides 46 of the respective interchangeable unit 38. Other cross-sections, such as rectangular, oval, etc, are possible in this case. Overall, four bolts 44 per interchangeable unit 38 therefore extend along the two opposite longitudinal sides 46 with a predefinable overhang. The associated gripping means in turn consist of individual hook elements 48 on the base unit 36, which are furnished at their edges with interruptions and delimit the respective longitudinal groove 40 of the base unit 36. The respective hook opening of the hook elements 48 is in any event selected such that an assignable bolt 44 is able to at least partially engage beneath to lock the hook element 48 and, as depicted in FIGS. 1 and 2, is thus held in the locking position. Like the bolts 44, the hook elements 48 are also positioned in pairwise groups opposite one another on the longitudinal sides of the base unit 36.

If, as depicted in FIG. 3, the interchangeable unit 38 is positioned on the base unit 36 from above, the interchangeable unit 38 moves from right to left, as determined by the system for the left-hand retaining device 30, until the hook elements 48 engage in a fixing manner over the bolts 44 leading, as a result, to the fixing or locking position shown in FIGS. 1 and 2. Locking for the right-hand retaining device 32 is accordingly achieved in the opposite direction from left to right. In any event, the hook elements 48, which are arranged in series behind one another along a longitudinal side of the base unit 36, delimit, with their openings pointing in one direction, a longitudinal guide 50 on the bottom side, the respective assignable bolts 44 being able to be positioned on said guide from above, as viewed on FIGS. 3 and 4, and, starting from this release position, said bolts then move to the left or right in a longitudinal movement direction into the locking position shown on FIGS. 1 and 2. As is also shown on the FIGS., the bolts 44 are held in their locking position inside the assignable hook elements 48 in their locking position by a stopping apparatus 52. The corresponding stopping apparatus 52 generally, and in the known manner, consists of a resilient pressure piece, which releases the path from the opening of the hook element 48 against the spring action as soon as the respective bolt 44 passes over the stopping apparatus 52 with a predefinable displacement force. Bolts 44 and hook elements 48 protrude over the longitudinal groove 40 of the base unit 36 and are arranged lying on a plateau which is substantially formed by the respective longitudinal guide 50.

As is particularly evident from FIG. 4, the interchangeable unit 38 may be configured in multiple parts and has a base part 54, which is configured to be parallelepipedic and has the rows of bolts, each with two bolts 44, along its two lower longitudinal sides, the axial spacing between said bolts, viewed in parallel with the longitudinal direction 14, corresponding to the spacing between two adjacent hook elements 48 in relation to the base of the respective circular opening. Furthermore, on the bottom side of the base part 54 facing the base unit 36, the base part has two strip-shaped longitudinal guides 56 protruding downwards, which allow secure guidance between the base part 54 and the base unit 36 and help reduce the sliding resistance accordingly. On the opposite upper side of the block or parallelepipedic base part 54, a perforation 58 is provided, the hole pattern being adapted to the ability to engage screws, with which a wide variety of forms of interchangeable units 38 can be positioned on the base part 54. Thus, the left-hand retaining device 30, as viewed on FIG. 1 to 3, with its adapter unit 60, which may be configured in a modular fashion to adapt to the corresponding operating task, is configured in a stepped design with two horizontally extending surfaces 62 and two vertically extending surfaces 64. A corresponding stepped structure is also selected for the right-hand retaining device 32 as viewed on the FIGS., although this has a different structure to the retaining device 30. The aforementioned surfaces 62, 64 could, particularly when the two retaining devices 30, 32 are interacting with one another, be provided as contact or support surfaces and thus as clamping means for third-party components, such as metal plates, for example, to be fixed. For example, however, the vertically extending surfaces 64 have at least one pendular support 66, which are used exclusively on both retaining devices 30, 32 as clamping means, with the result that the horizontally extending surfaces 62 thus do not necessarily need to be used as supports for third-party components.

Furthermore, the two adapter units 60 of retaining device 30 and retaining device 32 have individual gripper fingers at the point of the transition to the screwed-on base part 54, these being arranged in pairs 68 of gripper fingers when the base unit 36 and the interchangeable unit 38 are in the coupled-together state, and protruding both over the base unit 36 and over the base part 54. While the retaining device 32 has one pair 68 of gripper fingers in the centre only, the adapter unit 60 of the retaining device 30 has two such pairs 68 of gripper fingers, which delimit between them a space such that the pair 68 of gripper fingers of the retaining device 32 can engage in a flush manner, as is depicted on FIG. 3 by way of example. Also in this manner, the opposite pairs 68 of gripper fingers would be fundamentally suited to receiving individual third-party components between them as further clamping means. In an embodiment which is not shown, it would also be conceivable to control the gripper fingers of each pair 68 in a tong-like movable manner by means of an independent drive and to close them accordingly for a retaining or clamping movement. In this case, however, the pairs 68 of gripper fingers delimit between them a through area 70 as depicted on FIG. 3, with the result that a hydraulic or pneumatic control part, which is not shown and which is connected to the housing body 12, has space in every movement position of the retaining device 30, 32 in a receiving area 72 arranged therebetween and is guided with protruding bolt-like components in the through area 70 when the retaining devices 30, 32, as depicted in FIG. 3, are moved towards and onto one another, which usually corresponds to a clamping position, provided that the base units 36 coupled to the respective interchangeable units 38 follow this movement via the jaws 18 of the actuating apparatus 10.

It is understood that, as part of a modular system, a large number of different adapter units 60 can be used with the base part 54, with the result that a large number of handling and gripping opportunities are possible for the retaining device solution according to the teachings herein.

As is also shown on FIG. 1 to 3, engagement holes 74 are provided on the upper side of each retaining device 30, 32 and assigned to one another in pairs as receiving means, which are accordingly standardised and interact with adapted receiving pins or receiving bolts 76 of a storage apparatus 78, of which only one individual depositing plate 80 is shown in FIG. 5. The corresponding depositing plate 80 with its mounts 76 can be extended two-dimensionally on all sides or a plurality of such depositing plates 80, when multiplied in the cross-sectional and longitudinal directions, form the storage apparatus 78 in its entirety, which is thus constructed from standardised components, i.e. the depositing plates 80.

A handling apparatus (robot) engaging on the underside 82 of the housing body 12, said handling apparatus not being shown, is able to place the arrangement shown in FIG. 1 on its head, wherein the respective base unit 36 should be connected in a coupling and locked manner to the interchangeable unit 38 for the corresponding movement operation. In the accordingly reverse scenario, the unit shown in FIG. 1 can be positioned on the depositing plate 80 shown in FIG. 5 by means of the handling apparatus, only part of the housing body 12 according to FIG. 1 being shown in FIG. 5 for reasons of simplicity. For the corresponding positioning operation, it is essential that the two retaining devices 30, 32 are moved towards and onto one another in their next possible position, in which the middle pair 68 of gripper fingers of the retaining device 32 engages in the two spaced pairs 68 of gripper fingers of the opposite retaining device 30.

As part of the corresponding depositing operation, the receiving bolts 76, which are grouped in pairs, of the plate 80 then engage in the assigned engagement holes 74 of both retaining devices 30, 32. If the housing body 12 of the actuating apparatus 10 is only loaded with one retaining device 30 or 32, such an exchange operation can also take place solely for this one individual retaining device 30 or 32 by depositing on a depositing plate 80 of the storage apparatus 78. Although this is not explained in more detail, the interchangeable units 38 can also be separated manually from the respective assigned base unit 36 and deposited on the depositing plate 80 of the storage apparatus 78, the respective base unit 36 remaining connected to the jaws 18 on the actuating apparatus 10. The base unit 36, which then remains on the housing body 12, of the actuating apparatus 10, can then be moved by means of the handling system to another part of the storage apparatus 78 so that it can thus receive interchangeable units 30, 32 of the same or a different form. With the correspondingly modular design of the depositing system, a product range of third-party components in the form of rectangular components measuring 40×40 mm up to 200×200 mm and above can, for example, be handled with just a small number of retaining devices, for example in the form of the two retaining devices 30, 32 shown in the FIGS. Overall, it is clear that, with the retaining device solution described here, only one special adapter unit 60 now basically needs to be provided which can be adapted to the respective new component to be handled, whereas the other components, actuating device 10 with base units 36 and base parts 54, can remain the same. This leads to relevant cost savings and to a considerable simplification of the resulting handling operations. If the pairs 68 of gripper fingers can be moved in a tong-like manner by means of an appropriate drive, individual handling operations can also be performed with just one retaining device, in which case the respective retaining device acts as an active gripper part.

To facilitate the depositing operation of retaining devices 30, 32, for example on top of one another in pairs, a further detachable stopping device 84 is provided in its entirety as depicted on FIGS. 6 and 7. In this case, the respective retaining device 30, 32 is in turn securely connected by means of coupling elements 34 in the form of individual screw bolts to the respective assigned jaws 18 of the actuating apparatus 10. For this purpose, the respective further, second stopping apparatus 84 has a two-armed pivot lever 86, which is pivotably guided around a horizontally extending pivot pin 88. The respective pivot lever 86, which can be pivoted via the pivot pin 88 and is guided on the base unit 36 of each retaining device 30, 32, is supported with one free end on a spring-loaded pressure piece 90 of the base unit 36 and is provided with a contact surface at its other free end. The spring-loaded pressure piece 90 exerts a force on the pivot lever 86 of the retaining device 32 in the direction of a pivot movement around the pivot pin 88 in an anticlockwise direction. In the retaining device 30, on the other hand, as is shown in FIG. 6 in particular, the pivot lever 86 moves clockwise by means of the spring-loaded pressure piece 90 in the direction of a pivot movement around the pivot pin 88. In this manner, the lower part of the pivot lever 86, as depicted in FIG. 6, comes into a lower stopping or locking position, in which the bolt 44, which is arranged adjacent to the locking part of the pivot lever 86, as depicted in FIG. 6, remains in its fixing position inside the assigned hook element 48, which, for reasons of simplicity, is not shown in FIGS. 6 and 7. The same applies to the right-hand retaining bolt 44 of the retaining device 30.

As is also shown in FIGS. 6 and 7, an actuating pin 92 is connected to the respective depositing plate 80, said pin protruding by a predefinable actuating distance above the upper side of the depositing plate 80 and otherwise being securely connected to the bottom of said plate, for example by means of a screw connection. If the actuating apparatus 10 in its entirety, i.e. with its attachments, is moved from the position shown in FIG. 6 to the position shown in FIG. 7, in which both retaining devices 30, 32 are positioned with their free upper side on the facing upper side of the depositing plate 80, the free end of the respective actuating pin 92 comes into contact with the free locking bolt part of the pivot lever 86 along the contact surface thereof, which is then forced clockwise against the action of the spring-loaded pressure piece 90 for the retaining device 32 and anticlockwise for the retaining device 30 and pivoted into its release position as depicted on FIG. 7, the pressure piece 90 being compressed in this process and as such releasing the path for the aforementioned bolt 44 to come out of engagement with the associated hook element 48 and also for the bolt 44 of the other pair of bolts to be thus released accordingly. By a corresponding displacement movement of the jaws 18 inside the jaw guide 16 from right to left for the device 32 and from left to right for the device 30, the base units 36 arranged thereon can be moved from their coupled position as shown in FIG. 2 into the released position as shown in FIG. 3 and the respective interchangeable unit 38 with its released pair 44 of bolts remains on the storage apparatus 78. The actuating apparatus 10 can then be moved to a different depositing plate 80 by means of the handling apparatus with correspondingly stored holding devices, which can then be removed in the reverse order by means of the actuating apparatus 10 and the base units 36 arranged thereon from the depositing plate 80 for further gripping and clamping operations of third-party components. Despite the use of spring-loaded pressure pieces 90 for each pivot lever 86 of the further stopping apparatus 84, it is ensured that, in the event of the pressure pieces 90 failing, the assigned rocker-shaped pivot lever 86 always remains in its gravity-induced locking position as shown in FIG. 6, thus ruling out the possibility of failure.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A retaining device comprising at least a base unit and an interchangeable unit, said base unit and interchangeable unit being longitudinally movable relative to each other in a guided manner from a locking position, in which the base unit and the interchangeable unit are connected together, into a release position, in which the two units are separated, and vice versa.

12. The retaining device of claim 11, wherein, using a fixation device acting between the base unit and the interchangeable unit, in a movement position of the units relative to one another, the units are coupled to one another in the locking position and in a further movement position, which corresponds to the release position, the two units are uncoupled from one another.

13. The retaining device of claim 12, wherein the fixation device comprises individual fastener and associated gripper, which are moved towards and onto one another or moved away from one another and come into or out of engagement with one another respectively to reach the locking position or release position.

14. The retaining device of claim 13, wherein the fastener are formed by individual bolts, which are arranged in pairs, assigned to one another, on the two opposite longitudinal sides of the interchangeable unit, and wherein the gripper consists of individual hook elements on the base unit, which receive the assignable bolts via their hook opening for a locking operation in a longitudinal movement operation or release said bolts in the opposite direction.

15. The retaining device of claim 14, wherein at least some of the bolts are held in the locking position inside the assignable hook elements by means of a detachable stopping apparatus.

16. The retaining device of claim 14, wherein the hook elements are arranged in series behind one another and, with their openings pointing in one direction, delimit at least one longitudinal guide in which the respective assignable bolt may be positioned and moved from the release position along one longitudinal movement direction into the locking position.

17. The retaining device of claim 14, wherein the base unit comprises a plate-shaped base body, on which the respective hook element protrudes in one direction and at least one coupling element protrudes in the opposite direction, said coupling element interacting with an actuating apparatus, which moves the base unit in the opposite directions in parallel with the respective longitudinal movement direction for feed movements.

18. The retaining device of claim 11, wherein the interchangeable unit comprises individual clamping means, such as
contact or support surfaces and/or
pendular supports and/or
pairs of gripper fingers for fixing third-party components.

19. The retaining device of claim 11, wherein the interchangeable unit comprises receiving means on its side facing away from the base unit for depositing the interchangeable unit on a storage apparatus in the release position and wherein, the respective interchangeable unit is lifted off the corresponding storage apparatus coupled with the base unit.

20. A system consisting of at least two retaining devices of claim 11, wherein, in order to apply or release a clamping force by means of the clamping means, the interchangeable units locked to the base units can be moved towards and onto or away from one another by means of the actuating apparatus.

21. The retaining device of claim 11, wherein the interchangeable unit comprises receiving means on its side facing away from the base unit for depositing the interchangeable unit on a storage apparatus in the release position and wherein, by means of a further detachable stopping apparatus, the respective interchangeable unit is lifted off the corresponding storage apparatus coupled with the base unit.

22. The system of claim 20, wherein, using a fixation device acting between the base unit and the interchangeable unit, in a movement position of the units relative to one another, the units are coupled to one another in the locking position and in a further movement position, which corresponds to the release position, the two units are uncoupled from one another.

23. The retaining device of claim 22, wherein the fixation device comprises individual fastener and associated gripper, which are moved towards and onto one another or moved away from one another and come into or out of engagement with one another respectively to reach the locking position or release position.

24. The system of claim 23, wherein the fastener are formed by individual bolts, which are arranged in pairs, assigned to one another, on the two opposite longitudinal sides of the interchangeable unit, and wherein the gripper consists of individual hook elements on the base unit, which receive the assignable bolts via their hook opening for a locking operation in a longitudinal movement operation or release said bolts in the opposite direction.

25. The system of claim 24, wherein at least some of the bolts are held in the locking position inside the assignable hook elements by means of a detachable stopping apparatus.

26. The system of claim 24, wherein the hook elements are arranged in series behind one another and, with their openings pointing in one direction, delimit at least one longitudinal guide in which the respective assignable bolt may be positioned and moved from the release position along one longitudinal movement direction into the locking position.

27. The system of claim 24, wherein the base unit comprises a plate-shaped base body, on which the respective hook element protrudes in one direction and at least one coupling element protrudes in the opposite direction, said coupling element interacting with an actuating apparatus, which moves the base unit in the opposite directions in parallel with the respective longitudinal movement direction for feed movements.

28. The system of claim 20, wherein the interchangeable unit comprises individual clamping means, such as
contact or support surfaces and/or
pendular supports and/or
pairs of gripper fingers for fixing third-party components.

29. The system of claim 20, wherein the interchangeable unit comprises receiving means on its side facing away from the base unit for depositing the interchangeable unit on a storage apparatus in the release position and wherein, the respective interchangeable unit is lifted off the corresponding storage apparatus coupled with the base unit.

30. The system of claim 20, wherein the interchangeable unit comprises receiving means on its side facing away from the base unit for depositing the interchangeable unit on a storage apparatus in the release position and wherein, by means of a further detachable stopping apparatus, the respective interchangeable unit is lifted off the corresponding storage apparatus coupled with the base unit.
